(19) United States
(12) Patent Application Publication
(10) Pub. No.: US 2025/0052579 A1
(43) Pub. Date: Feb. 13, 2025

(54) Navigation system with pivoting inertial measurement units

(71) Applicant: SAFRAN ELECTRONICS & DEFENSE, Paris (FR)

(72) Inventors: Etienne BRUNSTEIN, MOISSY-CRAMAYEL (FR); Julien HALIOUA, MOISSY-CRAMAYEL (FR); Rémi ERNOULD, MOISSY-CRAMAYEL (FR); Simon SUBIAS, MOISSY-CRAMAYEL (FR)

(21) Appl. No.: 18/706,653

(22) PCT Filed: Nov. 3, 2022
(86) PCT No.: PCT/EP2022/080660

§ 371 Date: May 1, 2024

(30) Foreign Application Priority Data
Nov. 4, 2021 (FR) 2111692

(51) Int. Cl. G01C 21/16

(52) U.S. Cl. CPC G01C 21/166; G01C 21/188

(57) ABSTRACT

An inertial navigation system intended to be carried on board a vehicle includes at least two first inertial measurement cores of the type connected to the vehicle, and at least two second inertial measurement cores each secured to a turntable mounted with the ability to pivot about an axis of rotation. The axes of the second inertial measurement cores are angularly offset from one another. The system includes an electronic location calculation unit connected to the inertial measurement cores and a motor driving the rotation of the turntables to control them and employing at least a filtering algorithm to observe and correct a discrepancy between the positions provided by the measurement cores. The electronic unit controls the motor to pivot the turntables and process the measurements simultaneously coming from the second inertial measurement cores in at least two distinct angular positions of each turntable and of the first measurement cores.

The present invention relates to the field of navigation, and more specifically, the field of vehicle navigation, in particular submarines, and more specifically, submersible ship ballistic missiles nuclear powered (SSBN), in NATO terminology.

### TECHNOLOGICAL BACKGROUND

These submarines have the mission of remaining in the sea for several weeks, even several months, without being detected and being ready, in the case where the vital interests of the Nation would have been attacked by another state, to launch missiles on strategic targets of said state. As submarines are detectable and vulnerable when they are emerged, submarines of the abovementioned type remain immersed, ideally for the entire duration of their mission.

This extended immersion, in particular has the consequence that it prevents the crew of the submarine from determining its position from the position of celestial bodies or seamarks. It is no longer possible either to resort to a satellite positioning system (GPS, GLONASS, GALILEO, BEIDU), as the submarine is not able to receive satellite signals when it is immersed.

Yet, the precise knowledge of the position of the submarine in a landmark (longitude and latitude) is a datum essential for the accomplishment of its mission, since it also conditions the calculation of the trajectory of the missiles to their targets.

To this end, submarines are equipped with a navigation device, comprising at least one inertial unit arranged to measure the movements of the submarine. Thus, knowing a starting position of the submarine and integrating its dynamics, the navigation device can calculate the position of the submarine at each moment of its navigation.

Inertial units of the “gimbal”-type and inertial units of the “strapped-down”-type are known.

In the first type, the unit comprises an inertial measurement core which comprises: three linear inertial sensors, generally accelerometers, aligned with three axes of a measurement reference frame for measuring the specific force applied to the measurement core; and three angular sensors, like gyroscopes, for measuring rotations of the measurement core with respect to the inertial reference frame. The measurement core is mounted on the ship by way of a gimbal mechanism comprising torque motors controlled according to the measurements of the angular sensors so as to keep the orientation of the measurement reference frame fixed with respect to the local geographic reference frame. It is thus possible to determine, from the measurements of the linear sensors, the movement of the submarine in the landmark and deduce from this, a current position from a known position in this reference frame (for example, the starting position of the submarine). These inertial units are expensive; they further have a great mechanical complexity, and require a regular maintenance to guarantee their performance over time. These units are now abandoned in favour of those of the second type.

In the second type, the unit comprises an inertial measurement core (or IMU) which is fixed by suspensions in a casing directly fixed to the submarine and which comprises: three linear inertial sensors, generally accelerometers, aligned on three axes of a measurement reference frame for measuring the specific force applied to the submarine; and three angular sensors like gyroscopes for measuring rotations of the measurement reference frame with respect to the inertial, then geographic reference frame. A location algorithm can thus calculate, at each moment, a rotation matrix to pass from the measurement reference frame to the geographic reference frame and to project into the geographic reference frame, the measurements of the linear sensors which are then integrated, after compensation of the gravitational acceleration, to determine the movement of the submarine with respect to the geographic reference frame and deduce from this, its position in this reference frame.

The precision of these units is clearly highly dependent on the precision of each of the sensors which compose it. Yet, the measurements provided by the sensors are affected by errors of different types (bias of the accelerometers, bias or derivation of the gyrometers, scale factor error, axis misalignment of the axes of the accelerometers and of the gyrometers) that it is necessary to know to correct them. Furthermore, most of these errors vary over time, such that it is not sufficient to determine them in the factory to correct them once for it all.

To correct these errors, it is known to perform a hybridisation of the measurements of a first inertial unit with location information coming from a second source. The hybridisation is performed by using an algorithm such as a Kalman filter which observes a discrepancy between the measurements of the inertial unit and the location data coming from the second source to correct the measurements. This location information can be the known coordinates of the dock along which the submarine is located, the zero speed of the docked submarine, speed information coming from a loch, or also a position coming from a satellite positioning system.

A mixed type of inertial units are known, comprising a “strapped-down”-type inertial measurement core fixed on a turntable carried by a rotation mechanism enabling a rotation of the turntable about a vertical axis of rotation. This architecture obligates to have a very precise angle encoder on the axis of rotation to pass from the attitude provided by the core carried by the turntable to the attitude of the carrier vehicle on which the turntable is fixed.

A mixed type of inertial units are also known, comprising a “strapped-down”-type inertial measurement core is also known from, fixed on a turntable carried by a gimbal mechanism enabling a rotation of the turntable about two axes perpendicular to one another. The gimbal mechanism comprises motors which are controlled to bring the turntable into different orientations, so as to temporarily average the projection of the measurement errors in the geographic reference frame. Such a turntable is however complex from the mechanical standpoint and requests to use rotating collectors to ensure the electrical power supply of the inertial measurement core. Furthermore, this axis of rotation architecture does not make it possible to directly know the attitude (heading, pitch, sway) of the carrier, less than having very precise angle encoders on the axes and axes of rotation, the orientations of which are known (orthogonalities), to pass from the attitude provided by the core carried by the turntable to the attitude of the carrier vehicle on which the turntable is fixed.

A navigation device is known from document FR-A-2826447 comprising a navigation unit mounted on a motorized gimbal and a strapped-down-type navigation unit. It is provided to perform reversals of 180° of the gimbal-mounted navigation unit about two axes to annul the errors by averaging.

Document EP-A-3617656 describes a navigation device comprising two navigation units of parallel axes.

### Aim of the Invention

An aim of the invention is to provide an inertial navigation means having a reliable structure providing relatively precise navigation data.

### BRIEF SUMMARY OF THE INVENTION

The principle of the invention is based on taking measurements by means of an inertial measurement core mounted on a pivoting turntable. This makes it possible to average the derivations, except in the direction of the axis of rotation of the turntable. A navigation system on the surface of the Earth T has been illustrated in FIG. 8, with an inertial measurement core mounted to pivot about an axis of rotation aligned on the local vertical direction Zlocal, by considering that the sway and the pitch of the carrier vehicle are zero (which is the case, on average). The derivation Dv of the gyroscopes oriented about the axis of rotation aligned on the local vertical direction Zlocal is projected on the polar axis in derivation Dp equal to Dv·sin(Lat) and the derivation Dn oriented about the local North axis Nlocal is projected on the local polar axis in Dn·cos(Lat). The term sin(Lat) tends to 1 near the pole, such that the derivations projected on the polar axis Ap tend to increase, when the pole is approached. Yet, for a long-duration navigation (greater than a few days), the predominant error is the longitude error which corresponds to the integral, over time, of the derivations of the three gyroscopes projected about the polar axis Ap. However, the derivations of the gyroscopes which are projected in the equatorial plane (plane perpendicular to the polar axis Ap) generally create positional and heading errors at the period of twenty-four hours which are not divergent.

According to the invention, an inertial navigation system is provided, intended to be carried on board a vehicle, comprising at least two first inertial measurement cores of the connected type and two second inertial measurement cores each secured to a turntable mounted to pivot about an axis of rotation, the axes of rotation of the second inertial measurement cores being angularly offset to one another (in other words, they are not parallel to one another). The system further comprises at least one electronic location calculation unit which is connected to the inertial measurement cores and to a motor that drives the rotation of the turntable to control them and which implements at least one filtering algorithm to observe and correct a discrepancy between positions provided by the measurement cores. The electronic unit is programmed to control the motor in such a way as to cause the turntables to pivot and process the measurements coming from, on the one hand, second inertial measurement cores in at least two distinct angular positions of each turntable and, on the other hand, first measurement cores.

In FIG. 9, a system has been represented, the second measurement cores of which, each mounted to rotate about an axis of rotation, such that the second measurement cores have axes of rotation R1, R2, R3, arranged to form a trihedron. In the occupied position, the axis of rotation R1 is that of which the projection on the polar axis Ap is the most unfavourable and will greatly contribute to the divergence of the longitude error, while the axis of rotation R2 is that of which the projection on the polar axis Ap is the most favourable and will at least contribute to the divergence of the longitude error. It is understood that, with at least two axes of rotation forming an angle between them (i.e. two axes of rotation not parallel to one another), there will always be at least one of the axes of rotation in a position which is relatively favourable for processing derivatives, including in the vicinity of the poles.

Thus, the precision of the inertial measurement cores can be improved, in particular, during movements of the vehicle, in particular for long-duration movements, typically of several days, and this, under all latitudes.

Optionally, the system comprises three first inertial measurement cores and three second inertial measurement cores.

Thus, preferably, the axes of rotation of the turntables form a trihedron and the trihedron preferably has a trisector extending in a vertical direction of the vehicle, in the absence of sway and of pitch. The trisector is the straight line forming one same angle with all the axes of rotation.

Preferably, in relation to the first particular additional feature, the axes of rotation of the turntables extend into a horizontal plane of the vehicle.

Advantageously, the axes of rotation of the turntables are orthogonal to one another.

According to an additional feature, the filtering algorithm comprises at least two Kalman filters provided with measurements, each by at least one of the first measurement cores and at least one of the second measurement cores.

Thus, advantageously:
the filtering algorithm comprises three Kalman filters provided with measurements by two of the second measurement cores; or
the electronic navigation unit comprises at least two navigation modules, which are each connected to at least one of the first measurement cores and at least one of the two measurement cores, and which are each arranged to determine a first location of the vehicle from measurements provided by the measurement cores, each navigation module being associated with one of the filters; the electronic navigation unit determining a second location of the vehicle from an average of the first locations, weighted according to precision information provided by each filter.

According to an alternative additional feature, the filtering algorithm comprises a filter provided with data by the three first measurement cores and the three second measurement cores.

In a preferred version of the invention implementing an initialisation phase and a navigation phase, the precision of the second inertial measurement cores can be improved during the initialisation phase, while the vehicle has stopped and the precision of the locations of the first inertial measurement cores is improved during the navigation phase from the measurements of the second inertial measurement cores. The turntable is used during the navigation phase, to improve the precision of the navigation system. The rotations of the turntable are thus done with respect to the reference frame of the carrier vehicle. Preferably, the amplitude of the rotations is 180° such that, with a constant heading, the errors are averaged in the geographic reference frame. This has the advantage of limiting the angular amplitude of the rotations of the turntable and makes it possible to use a simple flexible cable (sufficiently flexible to not interfere with the movements of the turntable) instead of a rotating collector, to connect the electronic unit to the second inertial measurement core. This makes it possible to simplify the architecture of the navigation system, by increasing the reliability and by decreasing the cost.

The electronic navigation unit is programmed to implement an initialisation phase, during which the carrier vehicle is immobile and the electronic unit controls the motors in such a way as to cause each turntable to pivot and processes measurements coming from the second inertial measurement cores in at least two distinct angular positions of the turntable in view of deducing errors from these, and a navigation phase during which the electronic unit compares the measurements of the second inertial measurement cores during this phase to correct errors of the first inertial measurement cores.

Thus, advantageously, the electronic control unit is programmed to, during the navigation phase, control the motors in such a way as to cause the turntables to pivot and process measurements of the second inertial measurement cores in at least two distinct angular positions of the turntables in view of deducing errors from these.

Other features and advantages of the invention will emerge upon reading the description below of particular and non-limiting embodiments of the invention.

### BRIEF DESCRIPTION OF THE DRAWINGS

Reference will be made to the accompanying drawings, among which:

FIG. 1 is a perspective, partial, schematic view of a submarine equipped with a navigation system according to the invention;

FIG. 2 is a perspective, schematic view of such a navigation system, according to a first embodiment;

FIG. 3 is a schematic view of one of the inertial cores of the navigation system according to the first embodiment;

FIG. 4 is a perspective, partial, schematic view of a navigation system according to a second embodiment;

FIG. 5 is a diagram showing the architecture of a part of a navigation system according to a third embodiment;

FIG. 6 is a perspective view showing the positioning of the axes of rotation with respect to the vertical in a navigation system according to a fourth embodiment;

FIG. 7 is a perspective view showing the positioning of the axes of rotation with respect to the vertical in a navigation system according to a fifth embodiment;

FIG. 8 is a diagram making it possible to view the navigation errors for a navigation system according to the prior art;

FIG. 9 is a view similar to FIG. 8 for the navigation system according to the invention.

### DETAILED DESCRIPTION OF THE INVENTION

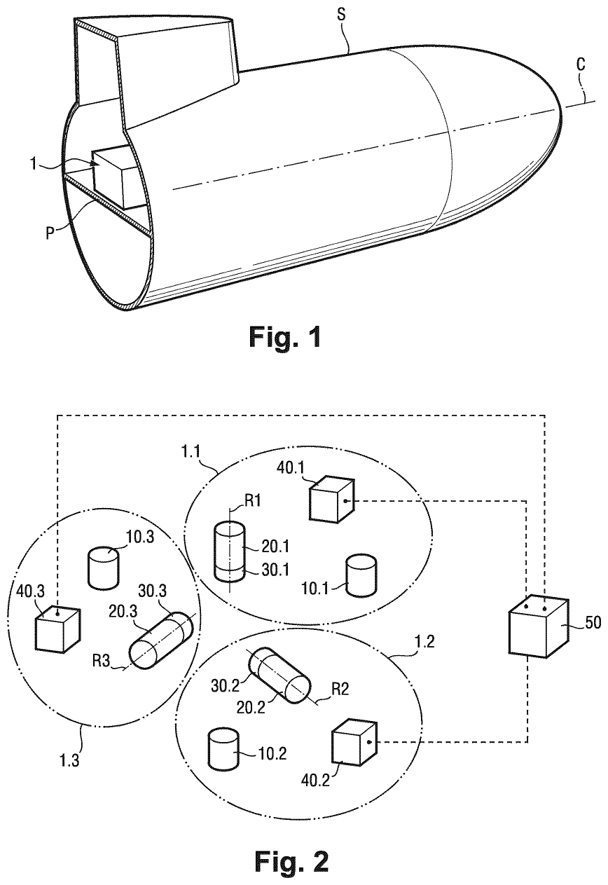

In reference to FIG. 1, the invention is described, in this case, in application to a submarine S partially represented in schematic form in FIG. 1. The submarine S is equipped with an inertial navigation system according to the invention, this system generally being referenced as 1.

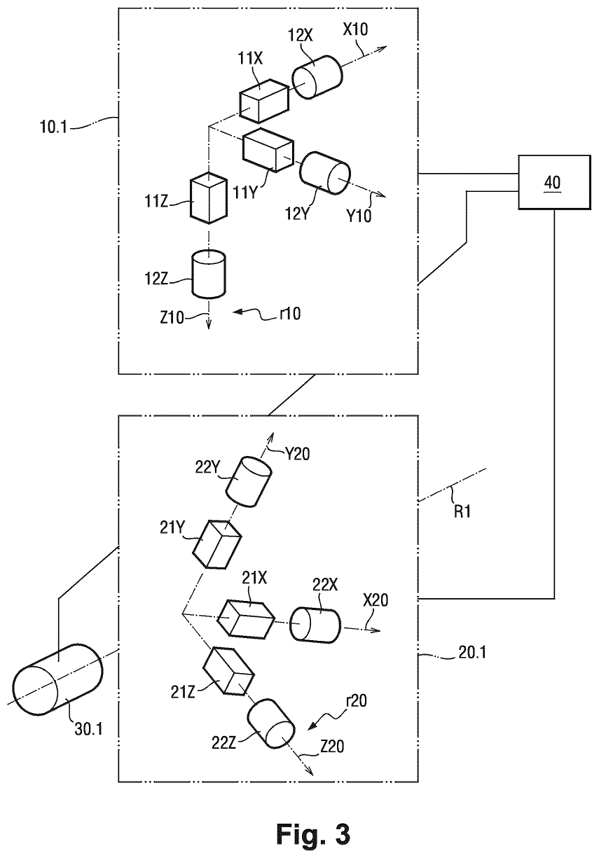

According to the first embodiment, and in reference to FIGS. 2 and 3, the inertial navigation system 1 comprises three inertial unit 1.1, 1.2, 1.3 respectively comprising a first inertial measurement core 10.1, 10.2, 10.3 and a second inertial measurement core 20.1, 20.2, 20.3.

The first inertial measurement core 10.1 comprises linear sensors 11x, 11y, 11z disposed about the axes X10, Y10, Z10 of a first measurement reference frame R10. The first inertial measurement core 10.1 also comprises angular sensors 12x, 12y, 12z disposed to measure the rotations of the measurement reference frame r10 with respect to an inertial reference frame. The first inertial measurement cores 10.2, 10.3 are identical to the first inertial measurement core 10.1. Each inertial measurement core is suspended in a casing to limit the impacts and vibrations felt by the sensors. The linear sensors are accelerometers of the conventional type and the angular sensors are, in this case, vibrating resonator gyroscopes, as such hemispherical resonator (HRGs) gyroscopes given the precision sought. It is alternatively possible to use another type of gyroscopes, like laser gyros or fibre-optic gyroscopes.

The first inertial measurement core 10.1, 10.2, 10.3 is of the “strapped-down” type and is fixed to a wall P of the submarine S, optionally via a suspension, such that the first measurement reference frame r10 has its first axis X10 parallel to the heading line of the submarine S (i.e. that the axis X10 is parallel to the longitudinal direction of the submarine S), its second axis Y10 perpendicular to the first axis X10 and, in this case, oriented starboard, and its third vertical axis 210 (i.e. that the axis Z10 is perpendicular to the floor of the submarine and extends vertically when the pitch and the sway are zero) and oriented downwards.

The second inertial measurement core 20.1 is secured to a motorized turntable 30.1 mounted on the wall P to pivot about one single axis R1. The second inertial measurement core 20.1 comprises linear sensors 21x, 21y, 21z disposed about the axes X20, Y20, Z20 of a second measurement reference frame r20 and of the angular sensors 12x, 12y, 12z disposed to measure the rotations of the measurement reference frame r20 with respect to an inertial reference frame. The linear sensors and the angular sensors are, for example, of the abovementioned type. The axes X20, Y20 and Z20 of the second inertial measurement core perpendicular to one another with indifferent directions, but at least one of which is substantially vertical for more simplicity. The motorized turntable 30.1 is associated with an electrical motor making it possible to control the rotation of the turntable 30.1 to bring the turntable 30.1 in at least three angular positions about the axis R1, namely the positions 0°, +1200, −120° with respect to the wall P (and therefore to the submarine S). The inertial measurement cores 20.2, 20.3 are identical to the inertial measurement core 20.1 and are mounted on motorised turntables 30.2, 30.3 mounted on the wall P to rotate about the axis of rotation R2, R3.

In this first embodiment of the invention, the axes R1, R2, R3 are inclined by around 54° with respect to the vertical of the submarine S (that is the perpendicular to the horizontal plane in the absence of sway and of pitch of the submarine) and are at 90° from one another to form an orthogonal trihedron.

The linear sensors and the angular sensors of the first measurement core 10.1, 10.2, 10.3, and the linear sensors and the angular sensors of the second measurement core 20.1, 20.2, 20.3 are connected, respectively, to an electronic processing circuit 40.1, 40.2, 40.3 (or navigation module) which is programmed to recover the signals coming from the sensors and process them by implementing at least one location algorithm (more commonly called inertial navigation algorithm) which is arranged to calculate, in real time:
from signals from sensors of the first measurement core, of the first pieces of positional (latitude, longitude, altitude), speed and attitude information (heading angles, sway and pitch of the inertial measurement core) of the first inertial measurement core in question;
from the signals of the sensors of the second measurement core, of the second pieces of positional (latitude, longitude, altitude), speed and attitude information (heading angles, sway and pitch of the inertial measurement core) of the second inertial measurement core in question.

The electronic processing circuits 40.1, 40.2, 40.3 are each associated with a Kalman filter which observes the positional discrepancy between the two locations coming from the inertial measurement cores 10.1, 10.2, 10.3 and 20.1, 20.2, 20.3 and which integrates in a state vector, the inertial errors of the two inertial measurement cores 10.1, 10.2, 10.3 and 20.1, 20.2, 20.3 and develops a covariance matrix of estimation errors of latitude and of longitude. This filter also has the position and/or the absolute speed known when the submarine is docked (at zero speed) or when the absolute position and the absolute speed are provided by another means (for example, a satellite location system): the absolute position and the absolute speed are grouped together as “external information”. The filter permanently observes the positional discrepancy provided by the two inertial measurement cores, as well as the positional discrepancy or speed between the location information provided by the first inertial measurement core and the external information. The two locations are looped (i.e. corrected) periodically by the inertial errors estimated by the filter.

The electronic processing circuits 40.1, 40.2, 40.3 are connected to an electronic location (or control) calculation unit 50 for providing the latter with the first pieces of positional, speed and attitude information, as well as the covariance matrix of the estimation errors of latitude and of longitude. Indeed, like the Kalman filter of each electronic processing circuit 40.1, 40.2, 40.3 permanently and precisely observes the positional discrepancy between the locations (position, attitude) provided speed, respectively by the two inertial measurement cores, the two locations will, thanks to looping, provide almost identical positions. Therefore, it is sufficient to provide one of the two positions to the users of the system and, preferably, the positional, speed and attitude information of the first measurement core, which make it possible to directly obtain the attitude of the submarine. The motors of the motorised turntables 30.1, 30.2, 30.3 are connected via the electronic processing circuits 40.1, 40.2, 40.3 to the electronic location unit 50 to be controlled by it.

The electronic location calculation unit 50 comprises a computer, like a processor, and a memory containing a program comprising instructions arranged for the implementation of the method according to the invention.

The program observes the positional discrepancy between the locations coming from the inertial units 1.1, 1.2, 1.3 and which integrates, in a state vector, the inertial errors of the inertial units 1.1, 1.2, 1.3.

The method of the invention implemented during the execution of the program by the electronic unit 50 comprises an initialisation (or calibration) phase and a navigation phase.

During the initialisation phase, the vehicle is immobile and the electronic unit 50 controls the motor in such a way as to cause the turntables 30.1, 30.2, 30.3 and the inertial units 1.1, 1.2, 1.3 to pivot to collect measurements taken by each second inertial measurement core 20.1, 20.2, 20.3 in at least two distinct angular positions (in this case, three positions) of the turntable 30.1, 30.2, 30.3.

During the navigation phase, the electronic unit 50 is programmed to collect the measurements of the inertial units 1.1, 1.2, 1.3 and compare them to develop the navigation of the submarine S.

The navigation of the submarine S is based on third pieces of positional information (latitude, longitude, altitude), speed and attitude (heading angles, sway and pitch of the submarine S). These third pieces of positional, speed and attitude information of the submarine S are obtained by calculating a weighted average of the first pieces of positional, speed and attitude information of the inertial units 1.1, 1.2, 1.3. Two weighting coefficients are respectively associated with the first pieces of positional, speed and attitude information of the inertial units 1.1, 1.2, 1.3. The first weighting coefficients α₁, α₂, α₃ equal ⅓ in nominal operation mode. If one of the inertial units is faulty or that one of the inertial units is deemed less efficient, it is possible to modify the first weighting coefficients correspondingly. For example, if the inertial unit 1.3 is faulty, the first weighting coefficient α₃ equals 0 and the first weighting coefficients α₁, α₂ equal ½, which makes it possible to deviate the measurements of the faulty inertial unit 1.3. The second weighting coefficients are determined according to the standard deviation of the errors of each inertial unit 1.1, 1.2, 1.3 relating to the positional, speed, attitude information in question. Thus, the second weighting coefficient for the longitude equals

$$\frac{1}{σ {Lon}_{i}^{2}}$$

such that the following will be had:

$$Lop = \frac{{\sum }_{1}^{3} \frac{{α}_{i}}{σ {Lon}_{i}^{2}} \times {Lon}_{i}}{{\sum }_{1}^{3} \frac{{α}_{i}}{σ {Lon}_{i}^{2}}}$$

### With:

Lop the longitude provided by the navigation system to the submarine S,
Lonᵢ the longitude of the inertial unit 1.i,
α₁ the weighting coefficient associated with the longitude of the inertial unit 1.i,
σLonᵢ the standard deviation of the longitude error provided by the Kalman filter of the inertial unit 1.i.

The initialisation and navigation phases with the corresponding rotation operations will now be described in more detail.

When docked, for each inertial unit, a direct observation of the positional error of each inertial measurement core is sufficient (the error of an inertial measurement core and the discrepancy between the two inertial measurement cores can also be observed, which is the same thing, and also has the advantage during the passage in the sea to just have to interrupt the observation of the error of one of the two inertial measurement cores, the recalibration between the inertial measurement cores thus being able to be permanently left).

During the initialisation phase which is, in this case, docked, the electronic unit 50 controls the motors of the turntables 30.1, 30.2, 30.3 to bring the second inertial measurement cores 20.1, 20.2, 20.3 successively in three angular positions 0°, 120°, −120° (a rotation to one of these three positions is, in this case, performed around every hour).

The rotations with three angular positions of each inertial measurement core 20.1, 20.2, 20.3 with respect to the reference frame of the submarine S, make it possible to calibrate the three biases of the accelerometers, the three derivatives of the gyroscopes and certain misalignments of gyroscope axes.

It is reminded that there is, in total, fifteen error terms being able to impact the precision of sea navigation:
three accelerometer biases Bx, By, Bz,
three gyroscope derivatives Dx, Dy, Dz,
three gyroscope scale factor errors Fx, Fy, Fz,
six misalignments of gyroscope axes Kxy, Kxz, Kyx, Kyz, Kzx, Kzy.
   Below, an example of a calibration is given for a vertical axis of rotation. All the errors mentioned below are observable in the case being studied, namely with an axis of rotation having an inclination less than 60° with respect to the vertical.

At constant latitude, the twelve errors of gyroscopes lead to eight of combinations independent errors: five combinations impact the north derivative and three combinations impact the vertical derivative. These two derivatives in the geographic reference frame are observable via the positional recalibrations of the docked navigation. The axis Z being vertical, the following is had:

$$North derivation = [ Dx - Ω . sin ( Lat ) . Kxz ] . cos ( heading ) -$$

$$[ Dy - Ω . sin ( Lat ) . Kyz ] . sin ( heading ) -$$

$$[ Kxy + Kyx ] . sin ( 2. heading ) . Ω . cos ( Lat ) / 2 +$$

$$Fx . ( 1 + cos ( 2. heading ) ) . Ω . cos ( Lat ) / 2 +$$

$$Fy . ( 1 - cos ( 2. heading ) ) . Ω . cos ( Lat ) / 2$$

$$Vertical derivative = - [ Dz - Ω . sin ( Lat ) . Fz ] -$$

$$Kzx . Ω . cos ( Lat ) . cos ( heading ) + Kzy . Ω . cos ( Lat ) . sin ( heading )$$

where Ω is the rotational speed of the Earth and Lat is the latitude.

Thus, for a given heading, an equation with five unknown is had and another equation with three other unknowns is had. In theory, five different headings should therefore be necessary to observe all the unknowns. However, in the application in question, the gyroscopes chosen have a very stable scale factor: it is therefore no longer necessary to identify the scale factor errors Fi during each docked alignment. Therefore, three unknowns per equation remain, therefore requiring three different heading values for their identification.

The initialisation phase with the rotation about the axis Z therefore makes it possible to precisely identify, when docked, the following errors (or combinations of errors):
Dx−Ω·sin(Lat)·Kxz;
Dy−Ω·sin(Lat)·Kyz;
Dz;
Kxy+Kyx;
Kzx;
Kzy.

It will be noted that it is not necessary to occupy very precise angular positions. A turntable 30 of mediocre precision (to the closest degree) can be sufficient. Indeed, the inertial unit 1.i measures precisely the heading rotations induced by the turntable and the need is to cause the heading to vary “sufficiently” to create observability (such that the projections of the errors notably change from one position to the other).

The method of the invention therefore makes it possible to identify the three gyroscope derivatives (with misalignment errors of close axes for Dx and Dy) before sea departure, which is essential to ensure a location precision, making it possible for a navigation of several days to several weeks without positional recalibration.

Moreover, the fact that Kxy and Kyx are not separable is not detrimental, only the sum of the two errors will impact the sea navigation and this sum will have been identified when docked.

It will be noted that this analysis is voluntarily simplified to facilitate explanations. In reality, the observability of the different error terms that the use of the Kalman filter will provide, will be slightly different. As an example, the Kalman filter will also benefit from the effects induced during the rotations of the turntable, which the preceding formulas do not convey.

The initialisation or calibration of the inertial unit 1.i is performed by the Kalman filter of each inertial unit 1.i which is arranged to model inertia (three positions, three speeds, three attitudes) and the errors of the inertial sensors (gyroscopes and accelerometers) of the inertial unit 1.i. The Kalman filter ensures an observation of the positional errors (latitude and longitude) provided by the inertial unit 1.i thanks to the knowledge of the position of the submarine S (when docked). The state matrix of the Kalman filter knows the attitude of the inertial unit (heading, in particular), which enables it to go back to the observable basic errors (or groups of errors).

During the navigation phase, the inertial measurement cores 20.1, 20.2, 20.3 will thus be able to navigate by sea with calibrated errors (the six gyroscope error groups or terms and the three accelerometer biases).

During the navigation phase, the precision of the location will be optimal to the calibration latitude (i.e. the latitude of the dock), the combinations of error terms depending on the latitude are only decorrelated during a latitude variation. For example, if Kxz equals 10 μrad, a latitude variation of 20° causing to pass from 50° to 30° will induce an equivalent derivation of value Kxz. Ω·[sin(30°)−sin(50°)] that is 4·10⁻⁵°/h to be compared with an average derivation of 9.6·10⁻⁵°/h without calibration with the pivoting turntable.

However, the inertial measurement cores 10.1, 10.2, 10.3 have not been able to benefit from docked rotations. It results from this, that:
the two horizontal accelerometer biases have not been identified, their observability requires a heading change;
only two combinations of gyroscope errors have been able to be identified (the heading corresponding to the heading of each inertial measurement core 10.1, 10.2, 10.3 when docked and the scale factor errors being considered as insignificant), namely a north derivation and a vertical derivation.
   These two derivations are defined as follows:

$$North derivation = [ Dx - Ω . sin ( Lat ) . Kxz ] . cos ( heading\_dock ) -$$

$$[ Dy - Ω . sin ( Lat ) . Kyz ] . sin ( heading\_dock ) -$$

$$[ Kxy + Kyx ] . sin ( 2. heading\_dock ) . Ω . cos ( Lat ) / 2$$

$$Vertical derivation = - Dz -$$

$$Kzx . Ω . cos ( Lat ) . cos ( heading\_dock ) + Kzy . Ω . cos ( Lat ) . sin ( heading\_dock )$$

Subsequently, upon sea departure, the first heading change will decorrelate the error terms and highly impact the navigation precision, knowing that usually, the three derivations can develop over time in an incompatible manner with the need, if they are not identified before the sea departure.

The method of the invention will make it possible to improve the precision of the inertial measurement cores 10.1, 10.2, 10.3 by using the inertial measurement cores 20.1, 20.2, 20.3, the precision of which is better, due to the initialization phase. The Kalman filter of each inertial unit 1.1, 1.2, 1.3 is arranged to observe the positional discrepancies between the two inertial measurement cores 10.1, 10.2, 10.3 and 20.1, 20.2, 20.3 and, thanks to the natural movements of the submarine S during navigation, the Kalman filter can go back to the basic errors of the first inertial measurement core 10.1, 10.2, 10.3, in the same way as if it had been able to benefit from rotations when docked. This comes down to performing a sea calibration of the first inertial measurement core 10.1, 10.2, 10.3, by benefiting, on the one hand, from the movements of the submarine S (replacing the rotations of a turntable) which make certain errors of the first inertial measurement core 10.1, 10.2, 10.3 observable and, on the other hand, from the precise positional reference provided by the second inertial measurement core 20.1, 20.2, 20.3 (which replaces the known position of the dock and will serve as a reference to the Kalman filter for the first inertial measurement core 10.1, 10.2, 10.3). In other words, the hybridization ensured by the Kalman filter between the two inertial measurement cores 10.1, 10.2, 10.3 and 20.1, 20.2, 20.3 makes it possible to complete the calibration of the first inertial measurement core 10.1, 10.2, 10.3, the intrinsic precision of which will improve as the navigation continues.

The Kalman filter, to be effective, is preferably arranged to comprise in its error model, the errors of the two inertias (position, speed, attitudes) and the errors of the inertial sensors of each of the inertias, as well as the common contributors (sea currents, gravity anomalies, etc.).

Thus, after a few tens of navigation hours at sea and subject to the submarine S making regular heading changes, the first inertial measurement core 10.1, 10.2, 10.3 will approach the precision level of the second inertial measurement core 20.1, 20.2, 20.3. Then, the errors increase in the long term, the position obtained with the two inertial measurement cores 10.1, 10.2, 10.3 and 20.1, 20.2, 20.3 (which continue to be recalibrated to one another) will benefit from a gain of 1/√2 (that is around 0.7) on the non-common parts (inertial parts) with respect to one single inertial measurement core. By considering common contributors, the gain will only be around 0.8 (20%) on the position.

The speed and the heading developed by the system will also benefit from this hybridization between the two inertial measurement cores 10.1, 10.2, 10.3 and 20.1, 20.2, 20.3.

According to the present particularly advantageous implementation, the turntable 30.1, 30.2, 30.3 is pivoted during the navigation phase.

During the navigation phase, the electronic unit 2 then controls the motor to bring the turntable 30.1, 30.2, 30.3, and therefore the second inertial measurement core 20.1, 20.2, 20.3 into the following positions 0°, +180°, 0°, −180°, 0°, etc. The motor is more specifically controlled to perform rotations of the turntable 30.1, 30.2, 30.3 of +180° and −180° according to the sequence 0°→+180°→0°→−180°→0°, etc. by remaining for a predetermined and constant duration in each position (from a few minutes to a few hours). It is noted that the rotation can also be continuous to slowly pass from one position to another, for example at 30° per hour. If the submarine S has movements about the axis of rotation R1, R2, R3, the averaging will be less complete than in the absence of movement, but will remain, despite it all, quite effective in the long term (it is, in any case, more effective than remaining at a constant turntable angle). The second inertial measurement core 20.1, 20.2, 20.3, due to the rotations of the turntable 30.1, 30.2, 30.3, will therefore maintain a good location precision level.

In this variant, the rotations of the turntable 30.1, 30.2, 30.3 at sea make it possible to tend towards a subservient-type behaviour in the geographic reference frame: the errors will tend to be averaged in this reference frame, if the rotations of the turntable 30 are more frequent than the movements of the submarine S which will counteract this averaging effect. These rotations will have a second beneficial effect, which will be t facilitate the observability of the errors of the two inertial measurement cores 10.1, 10.2, 10.3 and 20.1, 20.2, 20.3 thanks to their relative angular movement, which will indirectly improve the precision of the location provided by the navigation system.

Further to this averaging effect, the action of hybridising the measurements of the inertial core 20.1, 20.2, 20.3 with those of the inertial core 10.1, 10.2, 10.3 will lead to creating a short-term stable positional reference (between two rotations): this makes it possible for the Kalman filter to observe certain errors of the inertial core 20.1, 20.2, 20.3, like accelerometer biases, thanks to the rotations.

It will also be noted that the heading rotations of the submarine S enable a time averaging, in the geographic reference frame, of the residual derivation following each of the axes of rotation R1, R2, R3, due to their inclination with respect to the vertical.

It will be noted that the action of having three inertial units enables a redundancy and, in case of defect of one of the inertial units, the identification of the faulty inertial unit.

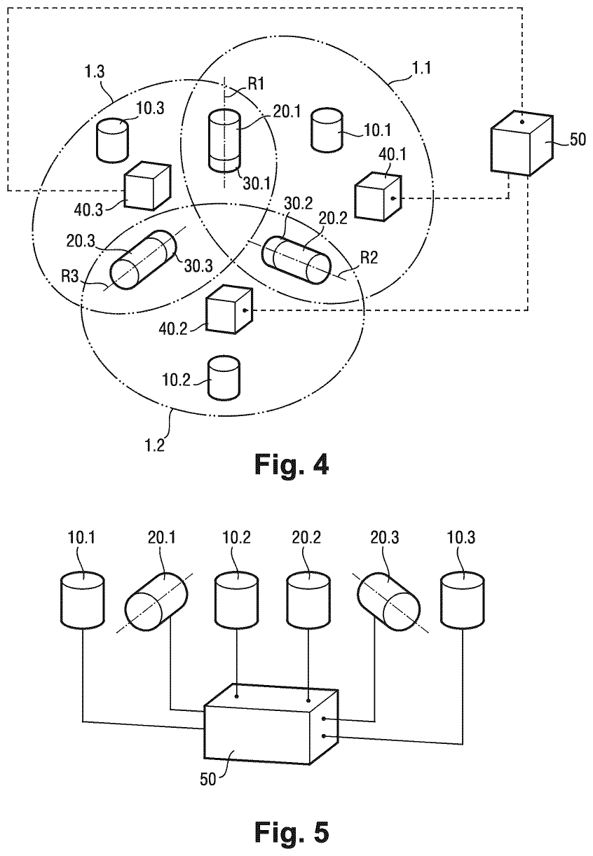

The elements which are identical or similar to those described above will have numerical references which are identical to the latter in the description below of other embodiments of the invention in reference to FIGS. 4 to 7.

According to the second embodiment represented in FIG. 4, the navigation system comprises, as above: three first inertial measurement cores 10.1, 10.2, 10.3; three second inertial measurement cores 20.1, 20.2, 20.3 each mounted on a motorised turntable 30.1, 30.2, 30.3; three electronic processing circuits 40.1, 40.2, 40.3; an electronic location unit 50 connected to the three electronic processing circuits 40.1, 40.2, 40.3.

The second embodiment differs from the previous one, in that each of the three electronic processing circuits 40.1, 40.2, 40.3 is connected to one of the first inertial measurement cores and to two of the second inertial measurement cores. Thus:
the electronic processing circuit 40.1 is connected to the first inertial measurement core 10.1 and to the second inertial measurement cores 20.1, 20.2 to form the inertial unit 1.1 and provide the first pieces of positional, speed, attitude information;
the electronic processing circuit 40.2 is connected to the first inertial measurement core 10.2 and to the second inertial measurement cores 20.2, 20.3 to form the inertial unit 1.2 and provide the first pieces of positional, speed, attitude information;
the electronic processing circuit 40.3 is connected to the first inertial measurement core 10.3 and to the second inertial measurement cores 20.1, 20.3 to form the inertial unit 1.3 and provide the first pieces of positional, speed, attitude information.

The operation of the navigation system according to the second embodiment is identical to that of the first embodiment, except in that each inertial unit utilises the measurements of three inertial measurement cores to develop the third pieces of positional, speed and attitude information.

Thus, the Kalman filter associated with each electronic processing circuit 40.1, 40.2, 40.3 can observe the discrepancies between the positional, speed, attitude information of the two second inertial measurement cores to which it is connected, and the axes of rotation of which are orthogonal to one another. This orthogonality of the axes of rotation is advantageous, as it makes the errors of each of these two inertial measurement cores more observable.

For example, if in continuing the navigation, the axis R1 is oriented about the polar axis, the longitude error of the second inertial measurement core 20.1 will develop as the integral of the gyroscope derivation which is about this axis. However, the axis of rotation R2 will be in the equatorial plane and will undergo a small development of the longitude error, as the polar derivation will be averaged. The Kalman filter being informed of these features, it can attribute the development of the longitude discrepancy between the two locations to the second inertial measurement core 20.1, and can thus identify the derivation of the second inertial measurement core 20.1 oriented about the axis of rotation R1 and compensate it for the continuation of the navigation.

This principle is generally applicable, whatever the orientations of the axes with respect to the Earth are, it is the orthogonality between the axes of the second inertial measurement cores 20.1, 20.2 which makes this possible. The Kalman filter can thus estimate in continuing the navigation (and therefore in continuing heading and latitude changes, which will modify the projections of the derivations in the geographic reference frame), the non-averaged residual derivations of the second inertial measurement cores 20.1, 20.2 to orthogonal axes of rotation, and improve the location precision of the inertial unit 1.1.

The action of making the two axes orthogonal makes it possible to have a “signature” (impact of the residual derivations on the position provided by the location) the most different as possible between the locations associated with the second inertial measurement cores 20.1, 20.2, which maximises their observability by the Kalman filter. In contrast, if the two IMU axes are aligned (all the vertical axes), the derivations of the two axes of rotation have an identical effect on the location and are totally unobservable (inseparable) by comparing the locations to one another.

This therefore also makes it possible to reveal a possible defect of one of the second inertial measurement cores and to identify the second faulty inertial measurement core.

It can be provided that only some of the inertial units comprises several second inertial measurement cores, for example, from the outset or in case of defect of one of the second inertial measurement cores. A redistribution of the inertial measurement cores between the inertial units can also be provided, according to the availability of each of the inertial measurement cores.

According to the third embodiment represented in FIG. 5, the navigation system comprises, as above: three first inertial measurement cores 10.1, 10.2, 10.3; three second inertial measurement cores 20.1, 20.2, 20.3, each mounted on a motorised turntable 30.1, 30.2, 30.3; an electronic location unit 50.

It differs from the first embodiment, in that the three first inertial measurement cores 10.1, 10.2, 10.3 and the three second inertial measurement cores 20.1, 20.2, 20.3 are connected to the electronic location unit 50, which comprises an electronic processing circuit implementing a Kalman filter receiving, at the entry, the positional, speed, attitude data of each of the six inertial measurement cores to comprise the errors of these six measurement cores. This embodiment is very precise, but plentiful in calculation resources.

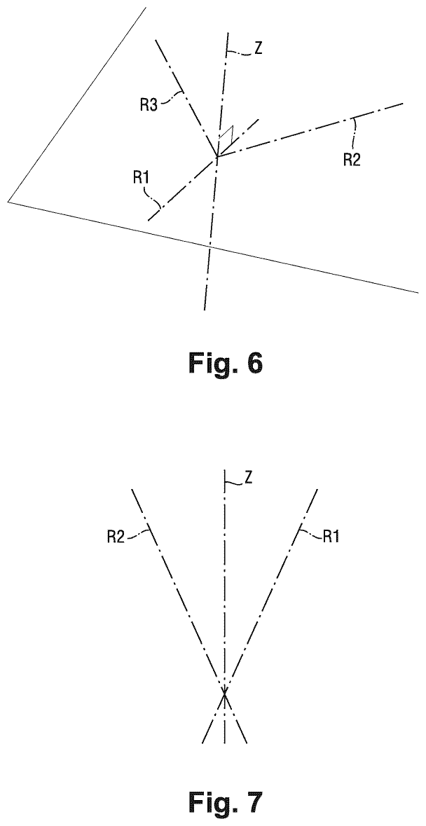

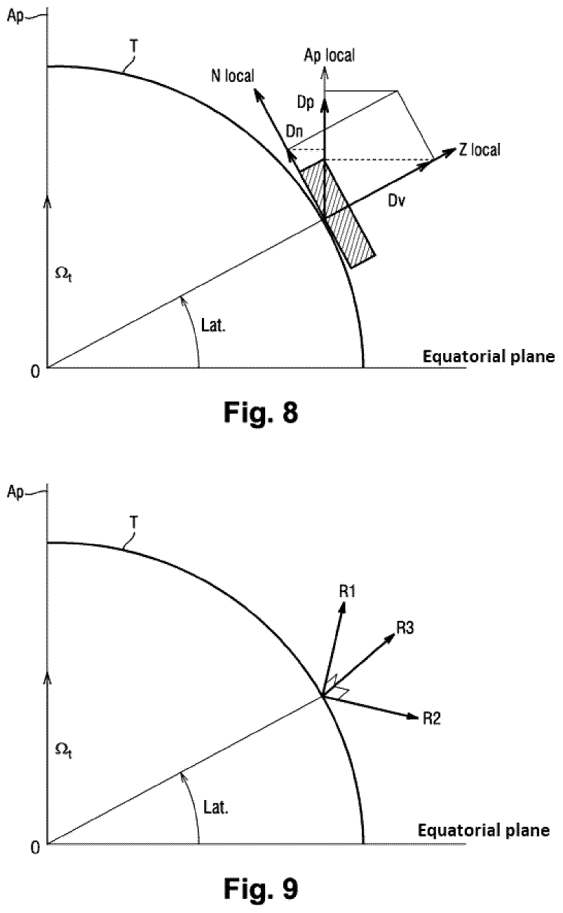

According to the fourth embodiment represented in FIG. 6, the navigation system comprises, as above: three first inertial measurement cores; three second inertial measurement cores, each mounted on a motorised turntable; three electronic processing circuits; an electronic location unit connected to the three electronic processing circuits.

The fourth embodiment differs from the previous one, in that the axes of rotation R1, R2, R3 are in the horizontal plane, which is favourable to the precision of the measurements, but prevents performing a precise initialization phase when docked.

The operation of the navigation system according to the fourth embodiment is identical to that the first embodiment.

To overcome this disadvantage, at least one of the second inertial measurement cores can be mounted on a turntable having two axes of rotation, one of which is substantially vertical.

In the fifth embodiment represented in FIG. 7, the navigation system comprises only: two first inertial measurement cores; two second inertial measurement cores, each mounted on a motorised turntable; two electronic processing circuits; an electronic location unit connected to the two electronic processing circuits.

The axes of rotation R1, R2 together form an angle of 90°, the bisector of which is the vertical axis Z of the submarine S.

Naturally, the invention is not limited to the embodiment described, but comprises any variant entering into the field of the invention, such as defined by the claims.

In particular, the navigation system can have a structure which is different from that described.

For example, the electronic navigation unit can comprise a calculation means, other than a processor. The electronic navigation unit can comprise a microcontroller or FPGA-type reconfigurable circuit. The electronic navigation unit can comprise remote navigation modules, or on the contrary, integrated in one same casing.

The Kalman algorithm can comprise one single filter or several filters.

By inertial measurement core, this means any inertial measuring device comprising linear sensors and angular sensors arranged to take measurements about these axes which are orthogonal to one another of a measurement reference frame. The inertial measurement core can comprise multi-axis sensors and/or mono-axis sensors, and can also comprise more than three linear sensors and/or more than three angular sensors.

The directions of the axes of the reference frames r10, r20 are indifferent and can be modified.

The number of inertial units, the number of first inertial measurement cores and the number of second inertial measurement cores can be different and, for example, greater than three.

Several sequences are possible, with and without limiting the number of rotations with respect to the carrier. If the number of rotations is limited, by enabling, for example, the range of −180° to +180°, this makes it possible to avoid using rotating collectors, which are expensive and sometimes not very reliable, but, on the contrary, this does not make it possible to average the errors in the geographic reference frame, due to heading movements of the carrier. Indeed, an average cycle consists, for example, of sequencing the following angular positions: 0°→+180°→0°→−180°→0°, etc. ideally in the geographic reference frame (in this case, 0° corresponding, for example, to aiming to the north and 180° corresponding to aiming to the south), but this subservience in the geographic reference frame must be done independently of the heading rotations of the carrier, which can counteract this sequence. Thus, if the carrier performs three heading rotations, it is necessary that the axis of rotation rotated by three rotations in the opposite direction, such that the IMU always aims in the same direction, hence the necessity for a rotating collector to make it possible to obtain an unlimited number of rotations, if needed. The alternative consists of sequencing the sequence presented above with respect to the carrier and not with respect to the geographic reference frame. This thus makes it possible to limit the angular articulation and to use cables being able, for example, to be wound, to enable the desired, but limited articulation. However, the quality of the time averaging in the geographic reference frame will be in function of the heading movements of the carrier, which will no longer be able to be fully compensated by rotations of the axis of the opposite direction.

The angular positions can be deviated by 120° (equispaced over a rotation) or not for the calibration when docked. The turntable can also be controlled to have less or more than three positions. It is noted that, when docked, more error terms are sought to be able to be observed (bias+calibrations) than at sea, therefore three positions are necessary; at sea, the more unstable errors are just sought to be averaged, namely particularly the three derivations of the gyroscopes, such that two positions are sufficient. The other errors at sea can no longer be observed, as there is no precise and continuous positional reference.

The turntable can be controlled to have more than two navigation phase positions.

Any mechanical means can be used to lock the turntable in rotation during navigation, if it is provided that the vehicle undergoes significant impacts between two rotations. The invention can also be achieved without any means for locking the turntable in rotation.

The inertial measurement core carried by the turntable can be connected to the electronic control unit by cables or flexible layers, or by rotating collectors.

In a variant, a Kalman filter can also be had, receiving information from only some of the first inertial measurement cores and information from all of the second inertial measurement cores.

The invention is applicable to other types of ships (surface or submarine) which need to know the position precisely and autonomously over long durations (“GNSS denied” context, for example, i.e. in a war context where satellite navigation systems are scrambled or deceived).

Even if the invention is particularly suitable for a use on submarines for long-duration navigations, it is however applicable to other types of vehicle and, in particular, surface ships, land vehicles, and air vehicles.

1. An inertial navigation system intended to be carried on board a vehicle, comprising at least two first inertial measurement cores of the type connected to the vehicle and at least two second inertial measurement cores each secured to a turntable mounted to pivot about an axis of rotation, the axes of rotation of the second inertial measurement cores being angularly offset to one another, the system comprising an electronic location calculation unit, which is connected to the inertial measurement cores and to a motor that drives the rotation of the turntables to control them and which implements at least one filtering algorithm to observe and correct a discrepancy between the positions provided by the measurement cores, the electronic unit being programmed to control the motor in such a way as to cause the turntables to pivot and process the measurements simultaneously coming from the second inertial measurement cores in at least two distinct angular positions of each turntable and of the first measurement cores.

2. The inertial navigation system according to claim 1, comprising three first inertial measurement cores and three second inertial measurement cores.

3. The inertial navigation system according to claim 3, wherein the axes of rotation of the turntables form a trihedron.

4. The inertial navigation system according to claim 3, wherein the trihedron has a trisector extending in a vertical direction of the vehicle in the absence of sway and of pitch.

5. The inertial navigation system according to claim 2, wherein the axes of rotation of the turntables extend in a horizontal plane of the vehicle.

6. The inertial navigation system according to claim 3, wherein the axes of rotation of the turntables are orthogonal to one another.

7. The inertial navigation system according to claim 2, wherein the filtering algorithm comprises at least two Kalman filters provided with measurements, each by at least one of the first measurement cores and at least one of the second measurement cores.

8. The inertial navigation system according to claim 7, wherein the filtering algorithm comprises three Kalman filters provided with measurements by two of the second measurement cores.

9. The inertial navigation system according to claim 7, wherein the electronic unit comprises at least two navigation modules which are each connected to at least one of the first measurement cores and at least one of the second measurement cores and which are each arranged to determine a first location of the vehicle from the measurements provided by the measurement cores, each navigation module being associated with one of the filters; the electronic unit determining a second location of the vehicle from an average of the first locations weighted according to precision information provided by each filter.

10. The inertial navigation system according to claim 2, wherein the filtering algorithm comprises a filter provided with data by the three first measurement cores and the three second measurement cores.

11. The inertial navigation system according to claim 1, wherein the electronic unit is programmed to implement an initialisation phase during which the carrier vehicle is immobile and the electronic unit controls the motors in such a way as to cause each turntable to pivot and processes the measurements coming from the second inertial measurement cores in at least two distinct angular positions of the table in view of deducing errors from these, and a navigation phase during which the electronic unit compares the measurements of the first inertial measurement cores with those of the second inertial measurement cores during this phase to correct errors of the first inertial measurement cores.

12. The inertial navigation system according to claim 11, wherein the electronic unit is programmed to, during the navigation phase, control the motors in such a way as to cause the turntables to pivot and to process the measurements of the second inertial measurement cores in at least two distinct angular positions of the turntables in view of deducing errors from these.

13. The inertial navigation system according to claim 5, wherein the axes of rotation of the turntables are orthogonal to one another.
